(19) United States
(12) Patent Application Publication
(10) Pub. No.: US 2021/0065441 A1
(43) Pub. Date: Mar. 4, 2021

(54) MACHINE LEARNING-BASED TECHNIQUE FOR EXECUTION MODE SELECTION

(71) Applicant: Advanced Micro Devices, Inc., Santa Clara, CA (US)

(72) Inventors: Ian Charles Colbert, La Jolla, CA (US); Michael John Bedy, Boxborough, MA (US)

(73) Assignee: Advanced Micro Devices, Inc., Santa Clara, CA (US)

(21) Appl. No.: 16/584,750

(22) Filed: Sep. 26, 2019

Related U.S. Application Data
(60) Provisional application No. 62/893,732, filed on Aug. 29, 2019.

(51) Int. Cl. G06T 15/80; G06N 20/00; G06T 15/00

(52) U.S. Cl. CPC G06T 15/80; G06T 15/005; G06N 20/00

(57) ABSTRACT

Described herein are techniques for generating a compiled shader program. The techniques include identifying input features of a shader program, providing the identified input features of the shader program to a trained model for selecting compiler operation values for shader programs, receiving, as output from the trained model, a compiler operation value for the shader program, and generating a compiled shader program based on the compiler operation value for execution on one or more compute units.

### CROSS REFERENCE TO RELATED APPLICATION

This application claims the benefit of U.S. Provisional Application No. 62/893,732, filed Aug. 29, 2019, which is incorporated by reference as if fully set forth herein.

### BACKGROUND

Graphics processing units include massively parallel processing units that execute shader programs. Due to the complexity of the hardware, compilers implement a variety of optimizations to enhance performance of the shader programs. Improvements to such compilers are constantly being made.

### BRIEF DESCRIPTION OF THE DRAWINGS

A more detailed understanding is provided by the following description, given by way of example in conjunction with the accompanying drawings wherein:

FIG. 1 is a block diagram of an example device in which one or more features of the disclosure can be implemented;

FIG. 2 is a block diagram of the device, illustrating additional details related to execution of processing tasks on the accelerated processing device, according to an example;

FIG. 3 is a block diagram showing additional details of the graphics processing pipeline illustrated in FIG. 2;

FIG. 4 is a block diagram of a compiler model training system, according to an example;

FIG. 5 is a block diagram of a compilation system according to an example; and

FIG. 6 is a flow diagram of a method for compiling shader programs, according to an example.

### DETAILED DESCRIPTION

Described herein are techniques for generating a compiled shader program. The techniques include identifying a set of one or more input features of a shader program, inputting the set of one or more input features of the shader program to a trained model for selecting compiler adjustments for shader programs, receiving, as output from the trained model, compiler adjustments for the shader program, and generating a compiled shader program based on the compiler adjustments for execution on one or more compute units.

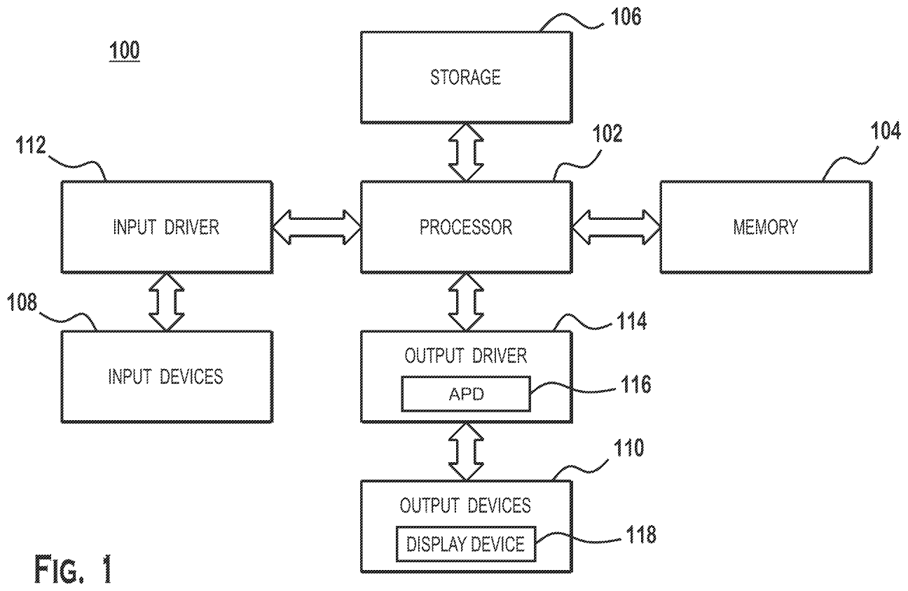

FIG. 1 is a block diagram of an example device 100 in which one or more features of the disclosure can be implemented. The device 100 includes, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 also optionally includes an input driver 112 and an output driver 114. It is understood that the device 100 includes additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display device 118, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 114 includes an accelerated processing device (“APD”) 116 which is coupled to a display device 118. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide (graphical) output to a display device 118. For example, it is contemplated that any processing system that performs processing tasks in accordance with a SIMD paradigm can be configured to perform the functionality described herein. Note that as used herein, the term “SIMD” encompasses variations to strict SIMD execution, such as single-instruction-multiple thread, in which parallel execution can have branching control flow, as well as other forms of execution. In general, the term “SIMD” as used herein refers to an execution paradigm in which a processor has a single instruction pointer that executes instructions for multiple items of data.

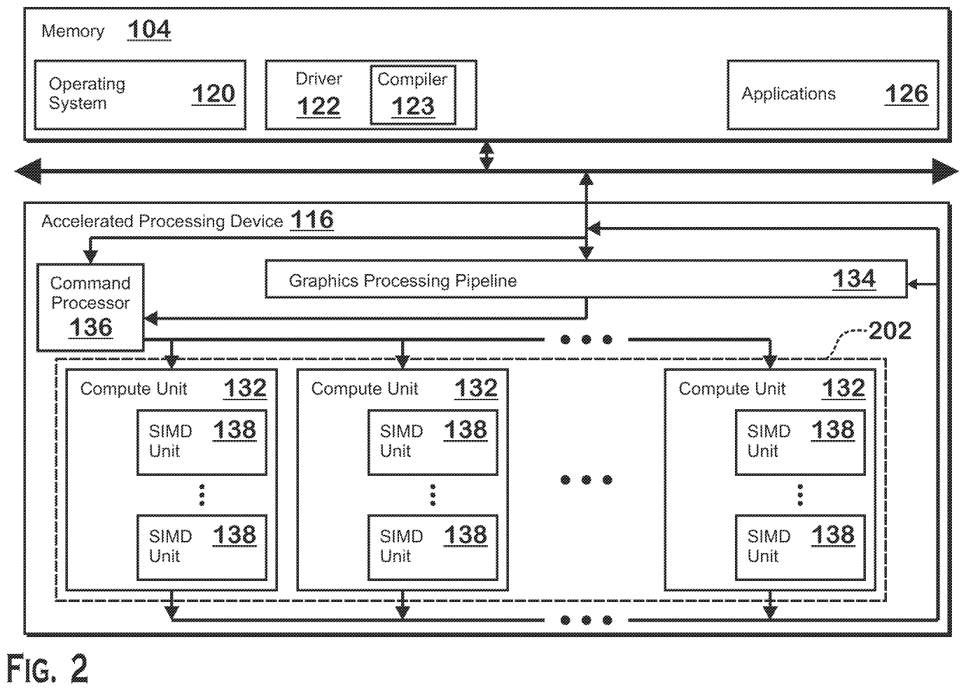

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. The driver 122 includes a just-in-time compiler 123 that compiles programs for execution by processing components (such as the SIMD units 138 discussed in further detail below) of the APD 116.

The APD 116 executes commands and programs for selected functions, such as graphics operations and non-graphics operations that are suited for parallel processing and/or non-ordered processing. The APD 116 is used for executing graphics pipeline operations such as pixel operations, geometric computations, and rendering an image to display device 118 based on commands received from the processor 102. The APD 116 also executes compute processing operations that are not related, or not directly related to graphics operations, such as operations related to video, physics simulations, computational fluid dynamics, or other tasks, based on commands received from the processor 102. The APD 116 also executes compute processing operations that are related to ray tracing-based graphics rendering.

The APD 116 includes compute units 132 that include one or more SIMD units 138 that perform operations at the request of the processor 102 in a parallel manner according to a SIMD paradigm. The compute units 132 are sometimes collectively referred to as “parallel processing units 202.” The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but executes that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow. In an implementation, each of the compute units 132 can have a local L1 cache. In an implementation, multiple compute units 132 share a L2 cache.

The basic unit of execution in compute units 132 is a work-item. Each work-item represents a single instantiation of a program that is to be executed in parallel in a particular lane. Work-items can be executed together as a “wavefront” on a single SIMD processing unit 138. The SIMD nature of the SIMD processing unit 138 means that multiple work-items are capable of executing in parallel simultaneously. Work-items that are executed together in this manner on a single SIMD unit are part of the same wavefront. In some implementations or modes of operation, a SIMD unit 138 executes a wavefront by executing each of the work-items of the wavefront simultaneously. In other implementations or modes of operation, a SIMD unit 138 executes different sub-sets of the work-items in a wavefront in parallel. In an example, a wavefront includes 64 work-items and the SIMD unit 138 has 16 lanes (where each lane is a unit of the hardware sized to execute a single work-item). In this example, the SIMD unit 138 executes the wavefront by executing 16 work-items simultaneously, 4 times.

One or more wavefronts are included in a “workgroup,” which includes a collection of work-items designated to execute the same program. An application or other entity (a “host”) requests that shader programs be executed by the accelerated processing device 116, specifying a “size” (number of work-items), and the command processor 136 generates one or more workgroups to execute that work. The number of workgroups, number of wavefronts in each workgroup, and number of work-items in each wavefront correlates to the size of work requested by the host. In some implementations, the host specifies the number of work-items in each workgroup for a particular request to perform work, and this act of specifying dictates the number of workgroups generated by the command processor 136 to perform the work. As stated above, the command processor 136 dispatches workgroups to one or more compute units 132, which execute the appropriate number of wavefronts to complete the workgroups.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

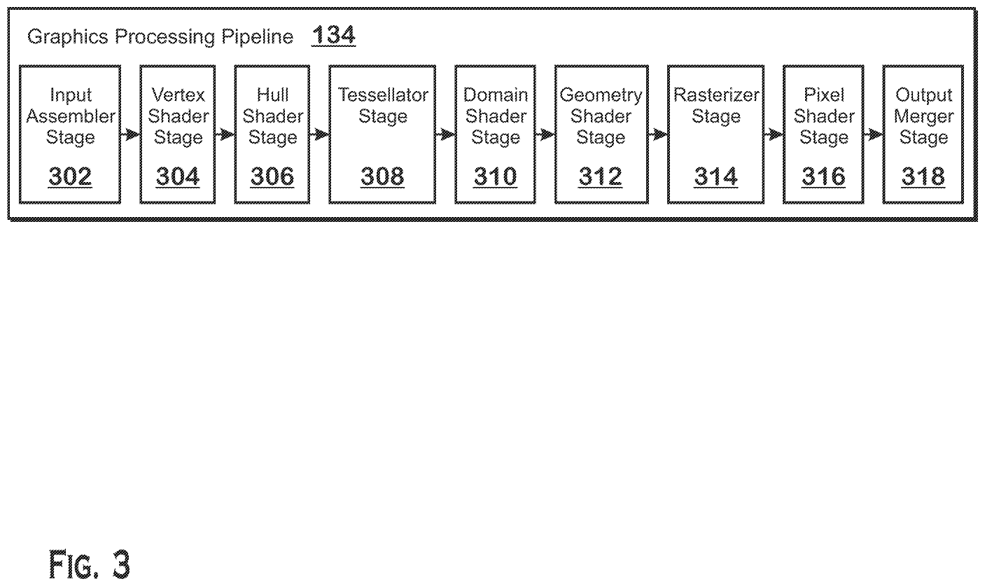

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132 that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 sometimes applies textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

The driver 122 includes a compiler 123 that compiles shader programs to be executed in the compute units 132. In some implementations, an offline compiler other than the compiler 123 shown compiles shader source code into an intermediate form and at runtime, the compiler 123 compiles the intermediate form into machine code instructions be executed on the compute units 132. Example intermediate forms include SPIR-V (“Standard portable intermediate representation-V”) for Vulkan or DXIL (“Direct X intermediate language”) for DX12 shader model 6. In other implementations, the compiler 123 compiles source code to machine code instructions. Herein, the act of compiling source code or an intermediate form to the final machine code instructions is sometimes referred to as “compiling a shader program” or by a similar phrase.

The compiler 123 implements a variety of compiler operations, such as optimizations, in the course of compiling shader programs. In general, the optimizations aim to improve performance by reducing execution time, reducing the utilization of computing resources (such as memory, registers, processing units, or the like), and/or by improving performance in some other way. In one example of a compiler operation, the compiler 123 selects the wavefront size at which a shader program should run. As described elsewhere herein, the compute units 132 execute shader programs. Instances of execution of shader programs are referred to herein as “kernels.” In an example of usage, an application 126 indicates to the APD 116 the manner in which to execute a kernel, in terms of the “size” of an execution of the kernel, where “size” indicates the number of work-items in the kernel. In some modes of operation, the application 126 also specifies how work-items are divided into workgroups. In other modes of operation, the APD 116 and/or driver 122 determines how to divide the work-items into workgroups. The size of the execution of the kernel, and the number of work-items to be executed per workgroup, determines how many workgroups are to be executed for a given kernel execution. These workgroups are executed by the APD 116. The APD scheduler 136 assigns the workgroups to compute units 132 for execution based on the availability of computing resources (e.g., how many workgroups are assigned to a particular compute unit 132, and whether other resources, such as memory, registers, or other resources are available). In addition to kernel size and workgroup size, it is also possible for a shader program to specify the wavefront size. The wavefront size indicates the number of work-items per wavefront.

As stated above, the driver 123 implements a variety of operations in the course of compiling shader programs, in order to improve performance. Such operations include selecting the wavefront size, determining whether to perform loop unrolling, enabling or disabling backface culling, determining whether to perform function inlining, modify the number of registers used, or other operations. These optimizations are sometimes referred to herein as “compiler operations.” Any particular compiler implementation is capable of implementing any combination of such operations, including operations not disclosed herein. Because the improvements in performance associated with such compiler operations are sometimes sensitive to hardware changes, new driver version releases frequently adjust how and when compiler operations are performed, in order to improve performance. Such adjustments are performed by skilled engineers that are familiar with the hardware and require a great deal of effort. Provided herein are machine learning-based techniques for training a machine learning model which is used during compilation to select and/or modify one or more compiler operations to perform in the course of compiling shader programs. Such machine learning techniques reduce the amount of effort involved with updating compilers 123 to improve the performance of shader programs that are output.

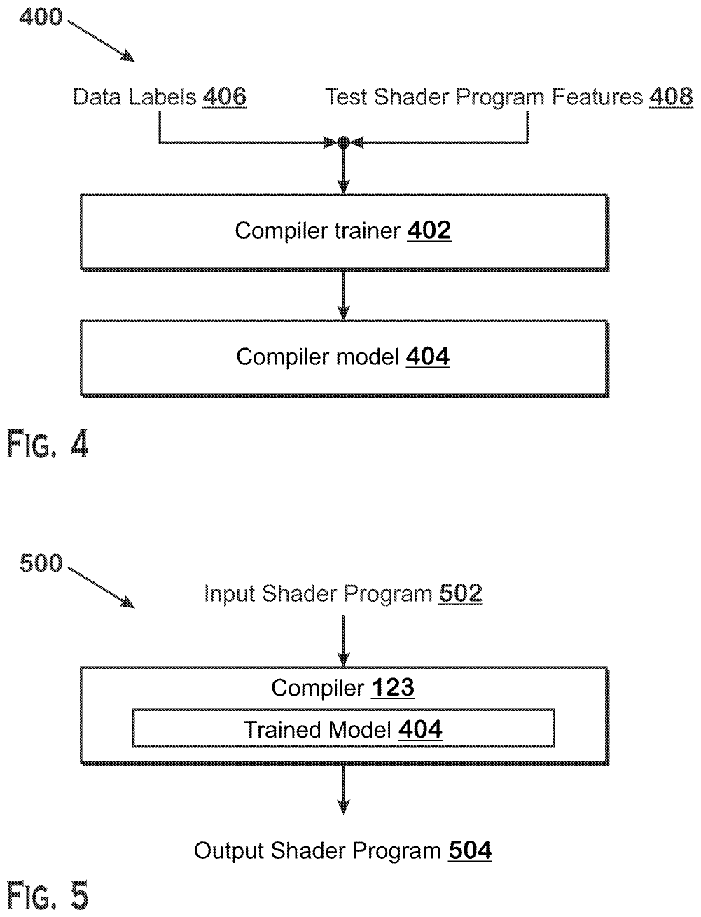

FIG. 4 is a block diagram of a compiler model training system 400, according to an example. The compiler model training system 400 includes a compiler trainer 402 and a compiler model 404. The compiler trainer 402 generates a trained compiler model 404 based on input data. The input data includes samples, each of which includes test shader program features 408 and data labels 406.

The test shader program features 408 are characteristics of test shader programs. The test shader programs are shader programs that are used to train the compiler model 404. The characteristics of the test shader programs are certain features of the test shader programs deemed to be inputs to the compiler model 404. Examples of such characteristics include number of registers used by the shader programs, number of instructions in the shader programs, the amount of memory used by the shader programs, and the number of work-items in a workgroup.

The data labels 406 include labels for each test shader program that indicate values for a set of compiler operations that lead to the compiled shader program being executed in a manner deemed to be most optimal. More specifically, the data labels 406 include indications, for each test shader program, of which set of one or more values for the one or more compiler operations results in performance deemed to be the most desirable.

The data labels 406 are set prior to the training illustrated in FIG. 4, by performing one or more test executions on each of the test shader programs. Each test execution is performed with a different combination of values for compiler operations. For each test execution, the performance is measured. Based on these measurements, the set of one or more values that results in the performance deemed to be the most desirable is selected as the data label 406. In some implementations, the “most desirable” performance is the fastest execution speed, meaning the fewest number of computer cycles to complete execution of a shader program. In other implementations, the “most desirable” performance is the lowest number of registers used, the lowest amount of power used, or is any other measure. The term “value for a compiler operation” means a specific selection of a value for a compiler operation. In the example compiler operation of wavefront size selection, the value for the compiler operation is the wavefront size. Other compiler operations include determining whether to perform loop unrolling (corresponding values: do perform loop unrolling, do not perform loop unrolling), enabling or disabling backface culling (corresponding values: do perform backface culling, do not perform backface culling), determining whether to perform function inlining (corresponding values: do perform function inlining, do not perform function inlining), modify the number of registers used (corresponding values: the possible number of registers used), or other operations.

In an example implementation, the data labels 406 are set in the following manner. A test execution system (not shown) receives a set of test shader programs. The test shader programs are, in various implementations, any type of shader program, such as compute shader programs, pixel shader programs, geometry shader programs, vertex shader programs, or other types of shader programs. The test execution system executes each test shader program in the following manner. For a particular test shader program, the test execution system executes that shader program for multiple execution test executions. The compiler operation for which the value is varied in each test execution is wavefront size. For each test execution, the test execution system uses a different wavefront size. For each test execution, the test execution system records the performance for each such test execution. Then the test execution system selects, as the data label for the shader program, the wavefront size that results in execution deemed to be most desirable.

As described above, there are several example measures for determining that execution is deemed most desirable. In one example, the measure is execution speed. In this example, the test execution system selects, as the data label for the shader program, the wavefront size that results in the fastest execution of the shader program. In another example, the measure is memory resource usage. In this example, the test execution system selects, as the data label for the shader program, the wavefront size that results in the lowest memory resource usage; where the term “memory resource” refers to any memory related resource, such as memory amount, cache hit rate, bandwidth, or other aspects of memory usage. In yet another example, the measure is power usage. In this example, the test execution system selects, as the data label for the shader program, the wavefront size that results in the lowest amount of power used. In still another example, the measure is register usage. In this example, the test execution system selects, as the data label for the shader program, the wavefront size that results in the lowest number of registers used.

As described above, a sample consists of a set of test shader program features 408 and a label 406. The test shader program features are input features to a machine learning classifier and the data labels 406 are a set of one or more values for compiler operations. More specifically, the test shader program features are features of a pre-compiler-operation version of the shader program that exists prior to the compilation operations. In an example, the compilation operations are compiler optimizations and the pre-compiler-operation version of shader program is a pre-optimization version of the shader program. In an example, the compilation operations include selection of a wavefront size and the pre-compiler-operation version of the shader program is the shader program before being modified to accommodate the selected wavefront size. In some examples, the compiler 123 generates an earlier version of a compiled shader program and then applies the compiler operations selected via the techniques described herein to further modify the earlier version of the compiled shader program. In some examples, the earlier version of the compiled shader program includes a defined number of instructions, a total number of registers used, a total amount of memory used, and other features, each of which are the input features.

In some implementations, multiple samples are generated for different test shader programs. Each sample is generated for a different compiler version. In some implementations, samples for older compiler versions are given a lower weight than samples for newer compiler versions. In general, different compiler versions generate different compiled shader programs that execute with different performance metrics. For example, it is possible for one version of a compiler to generate a compiled shader program for a test shader program that executes optimally with a first set of compiler operation values, but for a second version of a compiler to generate a compiled shader program for the same test shader program that executes optimally with a different set of compiler operation values. Thus, in some implementations, multiple samples are generated for individual test shader programs, where each sample includes data labels 406 and test shader program features 408 for a compiled shader program compiled with a different driver (compiler) version. Again, in some implementations, samples for compiled shader programs compiled by older compilers are given lower weights than samples for compiled shader programs compiled by newer compilers. Note, some driver versions referred to are historical driver versions created without the use of the techniques described herein. Thus the data from different driver versions represent human insights provided to the machine learning model.

The compiler trainer 402 implements a machine learning training technique to train a compiler model 404 based on the samples including the data labels 406 and the test shader program features 408. In some implementations, the training is performed to generate the compiler model 404 as an entity that is initially separate from the compiler 123 and that is ultimately integrated with or used by the compiler 123. The machine learning training technique trains the compiler model 404 to select a set of compiler operations (analogous to the data labels 406) given a set of input shader program features (analogous to the test shader program features 408) of an input shader program. In some examples, these machine learning training techniques are machine learning classifiers. Examples of classifiers include support vector machines and random forest classifiers; although in different implementations, any other type of machine learning classifier is used. To reiterate, the compiler trainer 402 trains the compiler model 404 to be able to select a set of compiler operations to use to modify a shader program, given the input features of the shader program.

Machine learning classifiers train their models by accepting a plurality of training samples. With each sample, the classifier refines the model. In general, providing an increased number of samples improves the performance of the trained model in terms of classifying a set of inputs. Samples can be weighted during training, where the weights modify the degree to which each sample refines the model.

In some examples, the machine learning training techniques are regression-based machine learning techniques. A regression-based machine learning technique is similar in some respects to a classification-based machine learning technique, except that with a regression-based machine learning technique, the output of the compiler model 404 is a continuous set of values. In other words, once trained, the compiler model 404 is capable of providing any set of compiler operation values instead of just those that are provided as labels to train the compiler model 404.

In the training system 400 of FIG. 4, each sample includes a set of data labels 406 for a single shader program and a set of test shader program features for that shader program 408. As described above, the data labels 406 are the set of compiler operations that result in the execution deemed to be optimal in the test executions of the test shader programs. Thus, the compiler trainer 402 is trained with samples including the input features of test shader programs and the compiler operation values that result in execution deemed to be optimal. The result of this training is a trained compiler model 404 that is used to select compiler operation values for a shader program based on input features of the shader program.

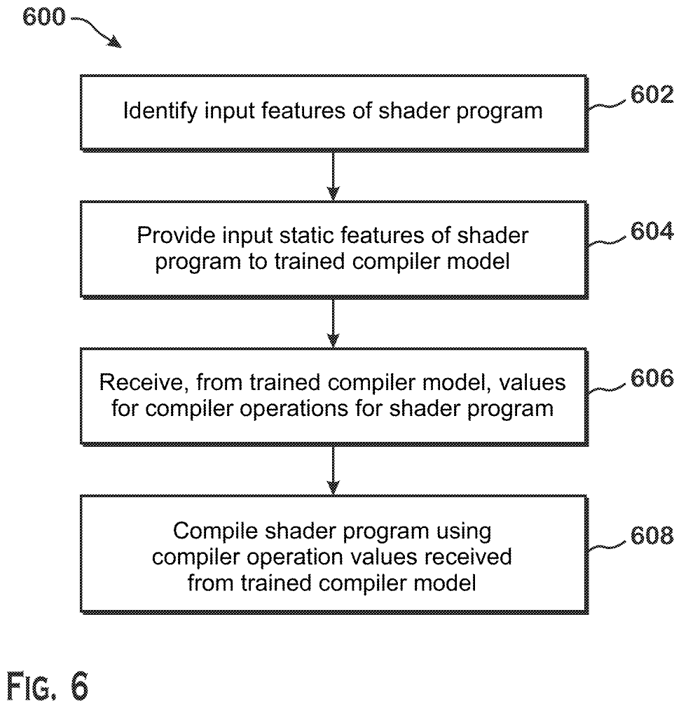

FIG. 5 is a block diagram of a compilation system 500 according to an example. The compilation system 500 includes the compiler 123, which includes a trained model 404, accepts an input shader program 502, and generates an output shader program 504. In some examples, the input shader program 502 is in the form of an intermediate representation generated by a different compiler than the compiler 123 or by an earlier pass of the compiler 123. The compiled shader program 504 includes machine language instructions to be executed on one or more compute units 132.

FIG. 6 is a flow diagram of a method 600 for compiling shader programs, according to an example. Although described with respect to the system of FIGS. 1-5, those of skill in the art will understand that any system, configured to perform the steps of the method 600 in any technically feasible order, falls within the scope of the present disclosure.

FIGS. 5 and 6 will now be discussed together. At step 602, the compiler 123 identifies the input features of the shader program. In some implementations, a compiler (such as the compiler 123) compiles source code into a near-final form in which features, such as register usage, memory usage, and other static resources, are specified. These features are the input features identified in step 602. At step 604, the compiler 123 applies these input features to the trained compiler model 404. As described elsewhere herein, the trained model is a machine learning model trained using training samples generated from test shader programs. The trained model 404 accepts input features as input and provides one or more compiler operation values as output at step 606. At step 608, the compiler compiles the source 502 into the compiled shader program 504, using the compiler operations obtained from the trained model 404.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the command processor 136, the graphics processing pipeline 134, the compute units 132, the SIMD units 138, any of the stages of the graphics processing pipeline 134, the compiler trainer 402, and the compiler 123) are, in various implementations, implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be mask works that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for generating a compiled shader program, the method comprising:
identifying input features of a shader program;
providing the identified input features of the shader program to a trained model for selecting compiler operation values for shader programs;
receiving, as output from the trained model, a compiler operation value for the shader program; and
generating a compiled shader program based on the compiler operation value for execution on one or more compute units.

2. The method of claim 1, wherein the input features comprise features of the shader program that are determined by instructions of the shader program.

3. The method of claim 1, wherein the input features comprise one or more of registers used by the shader program, memory used by the shader program, and number of instructions in the shader program.

4. The method of claim 1, wherein the compiler operation values comprise one or more of wavefront size, whether to perform loop unrolling, enabling or disabling backface culling, whether to perform function inlining, the number of registers used, or other values.

5. The method of claim 1, wherein the trained model comprises a machine learning-trained model trained for selecting a set of compiler operation values for shader programs given a set of input features.

6. The method of claim 1, further comprising generating the trained model through a training technique.

7. The method of claim 6, wherein generating the trained model comprises providing a set of samples to a model trainer, wherein each sample includes one or more input features for an executed test shader program and one or more compiler operation values selected to generate execution performance of the test shader deemed to be optimal.

8. The method of claim 7, wherein the set of samples includes multiple samples for a test shader program, each sample being for execution of the test shader program compiled with a different compiler version.

9. The method of claim 1, further comprising:
modifying the shader program based on the compiler operation value.

10. A computer system comprising:
a compiler; and
one or more compute units configured to execute shader programs,
wherein the compiler is configured to:
identify input features of a shader program;
provide the identified input features of the shader program to a trained model for selecting compiler operation values for shader programs;
receive, as output from the trained model, a compiler operation value for the shader program; and
generate a compiled shader program based on the compiler operation value for execution on the one or more compute units.

11. The computer system of claim 10, wherein the input features comprise features of the shader program that are determined by instructions of the shader program.

12. The computer system of claim 10, wherein the input features comprise one or more of registers used by the shader program, memory used by the shader program, and number of instructions in the shader program.

13. The computer system of claim 10, wherein the compiler operation values comprises one or more of wavefront size, whether to perform loop unrolling, enabling or disabling backface culling, whether to perform function inlining, the number of registers used, or other values.

14. The computer system of claim 10, wherein the trained model comprises a machine learning-trained model trained for selecting a set of compiler operation values for shader programs given a set of input features.

15. The computer system of claim 10, further comprising a trainer configured to generate the trained model through a training technique.

16. The computer system of claim 15, wherein generating the trained model comprises providing a set of samples to a model trainer, wherein each sample includes one or more input features for an executed test shader program and one or more compiler operation values selected to generate execution performance of the test shader deemed to be optimal.

17. The computer system of claim 16, wherein the set of samples includes multiple samples for a test shader program, each sample being for execution of the test shader program compiled with a different compiler version.

18. A non-transitory computer-readable medium storing instructions that, when executed by a processor, cause the processor to generate a compiled shader program, by:
identifying input features of a shader program;
providing the identified input features of the shader program to a trained model for selecting compiler operation values for shader programs;
receiving, as output from the trained model, a compiler operation value for the shader program; and
generating a compiled shader program based on the compiler operation value for execution on one or more compute units.

19. The non-transitory computer-readable medium of claim 18, wherein the input features comprise features of the shader program that are determined by instructions of the shader program.

20. The non-transitory computer-readable medium of claim 18, wherein the compiler operation values comprise one or more of wavefront size, whether to perform loop unrolling, enabling or disabling backface culling, whether to perform function inlining, the number of registers used, or other values.
